(19) United States
(12) Patent Application Publication
(10) Pub. No.: US 2025/0136085 A1
(43) Pub. Date: May 1, 2025

(54) HYBRID ELECTRIC VEHICLE CONTROL DEVICE

(71) Applicant: TOYOTA JIDOSHA KABUSHIKI KAISHA, Toyota-shi (JP)

(72) Inventor: Masaki HAYASHI, Iwakura-shi (JP)

(73) Assignee: TOYOTA JIDOSHA KABUSHIKI KAISHA, Toyota-shi (JP)

(21) Appl. No.: 18/751,518

(22) Filed: Jun. 24, 2024

(30) Foreign Application Priority Data
Oct. 25, 2023 (JP) 2023-183588

(51) Int. Cl. B60W 20/40; B60W 10/02

(52) U.S. Cl. CPC B60W 20/40; B60W 10/026; B60W 2510/244; B60W 2710/024; B60W 2710/0677; B60W 2710/086

(57) ABSTRACT

An electronic control unit of a hybrid electric vehicle including an engine and an electric motor, which are power sources for traveling, and a torque converter with a lockup clutch provided in a power transmission path between the electric motor and a pair of drive wheels, is capable of switching between automatic driving and manual driving traveling, and controls the engagement and disengagement of the lockup clutch LU in accordance with a predetermined engagement and disengagement condition during BEV traveling and during manual driving traveling, and brings the lockup clutch LU into engagement during BEV traveling and during automatic driving traveling.

### CROSS-REFERENCE TO RELATED APPLICATION

This application claims priority to Japanese Patent Application No. 2023-183588 filed on Oct. 25, 2023, incorporated herein by reference in its entirety.

### BACKGROUND

### 1. Technical Field

The present disclosure relates to a hybrid electric vehicle control device including an engine and an electric motor as power sources for travel, and a torque converter with a lockup clutch provided in a power transfer path between the electric motor and a pair of drive wheels.

### 2. Description of Related Art

There is known a hybrid electric vehicle control device including an engine and an electric motor as power sources for travel, and a torque converter with a lockup clutch provided in a power transfer path between the electric motor and a pair of drive wheels. Such a device is described in Japanese Unexamined Patent Application Publication No. 2023-93212 (JP 2023-93212 A), for example. The hybrid electric vehicle described in JP 2023-93212 A enables autonomous driving that does not require acceleration and deceleration operations by a driver, and manual driving that follows acceleration and deceleration operations by the driver.

### SUMMARY

JP 2023-93212 A indicates that the control state of the lockup clutch includes a disengaged state, a slip state, and an engaged state (meaning a fully engaged state excluding the slip state). However, there is no description of how engagement-disengagement control of the lockup clutch is performed during manual travel and autonomous travel. In general, engagement-disengagement control of a lockup clutch is performed according to a predetermined engagement-disengagement condition determined in advance.

When the lockup clutch is disengaged according to the predetermined engagement-disengagement condition during battery electric vehicle (BEV) travel in which only the electric motor is used as the power source, power is transferred in the torque converter via a fluid. In this aspect, the engine can be started responsively while suppressing a shock caused in a power transfer path, even if the required driving torque increases, for example. However, the drive torque and the rotational speed transferred to a pair of drive wheels fluctuate according to the performance characteristics of the torque converter, and therefore it is difficult to accurately control the drive torque and the rotational speed of the pair of drive wheels.

When the lockup clutch is engaged according to the predetermined engagement-disengagement condition during the BEV travel in which only the electric motor is used as the power source, power is transferred in the torque converter with a pump impeller and a turbine impeller directly connected to each other, and not via a fluid. In this aspect, the drive torque and the rotational speed transferred to the pair of drive wheels do not fluctuate according to the performance characteristics of the torque converter, and it is easy to accurately control the drive torque and the rotational speed of the pair of drive wheels. However, when the required driving torque increases and the engine is started responsively, for example, there is a possibility that a large shock is caused in the power transfer path.

The present disclosure has been made in view of the above circumstances, and an object of the present disclosure is to provide a hybrid electric vehicle control device capable of responsively starting an engine during manual travel and facilitating accurate control of the driving torque and the rotational speed of a pair of drive wheels during autonomous travel.

An aspect of the present disclosure provides a hybrid electric vehicle control device including: an engine and an electric motor as power sources for travel; and a torque converter with a lockup clutch provided in a power transfer path between the electric motor and a pair of drive wheels, in which:
the hybrid electric vehicle control device is able to switch between autonomous travel and manual travel;
engagement-disengagement control of the lockup clutch is performed according to a predetermined engagement-disengagement condition during battery electric vehicle travel in which only the electric motor is used as the power source and during the manual travel; and
the lockup clutch is engaged during the battery electric vehicle travel and during the autonomous travel.

In the hybrid electric vehicle control device according to the present disclosure, it is possible to switch between autonomous travel and manual travel, engagement-disengagement control of the lockup clutch is performed according to a predetermined engagement-disengagement condition during battery electric vehicle travel in which only the electric motor is used as the power source and during the manual travel, and the lockup clutch is engaged during the battery electric vehicle travel and during the autonomous travel. Consequently, it is possible to responsively start an engine during manual travel and facilitate accurate control of the driving torque and the rotational speed of a pair of drive wheels during autonomous travel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a hybrid electric vehicle including an electronic control unit according to an embodiment of the present disclosure, and is a functional diagram illustrating a main part of a control function for various types of control in a hybrid electric vehicle;

FIG. 2 is a schematic diagram of a hydraulic system for controlling the operation of the clutch K0, the torque converter, and the automatic transmission shown in FIG. 1;

FIG. 3 is an exemplary lockup switching map determined in advance as a connection and disconnection condition of the lockup clutch; and

FIG. 4 is an example of a flowchart illustrating a control operation of the electronic control device illustrated in FIG. 1.

### DETAILED DESCRIPTION OF EMBODIMENTS

Hereinafter, an embodiment of the present disclosure will be described in detail with reference to the drawings. Note that, in the embodiments, the drawings are simplified or modified as appropriate, and the dimensional ratios, shapes, and the like of the respective portions are not necessarily drawn accurately.

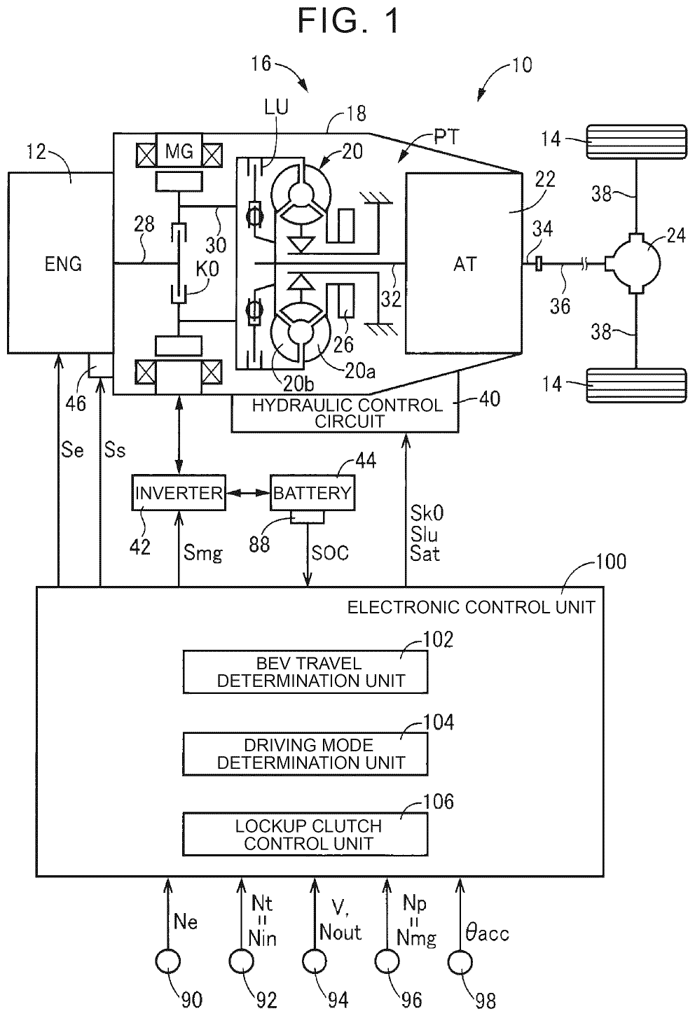

FIG. 1 is a schematic configuration diagram of a hybrid electric vehicle 10 (hereinafter, simply referred to as a “vehicle 10”) including an electronic control unit 100 according to an embodiment of the present disclosure, and is a functional block diagram illustrating a main part of a control function for various types of control in the vehicle 10.

The vehicle 10 includes an engine 12 and an electric motor MG, which are power sources for traveling, and a power transmission device 16 provided in a power transmission path PT between the electric motor MG and the pair of drive wheels 14. The vehicles 10 are hybrid electric vehicle. Further, the vehicle 10 includes a hydraulic control circuit 40, an inverter 42, a battery 44, a starter motor 46, and an electronic control unit 100.

The engine 12 is a well-known internal combustion engine. the electric motor MG is, for example, a so-called motor generator having a function as an electric motor that generates mechanical power from electric energy (an electric motor function) and a function as a generator that generates electric energy from mechanical power (a generator function). The battery 44 exchanges electric power with the electric motor MG via the inverters 42. The electric motor MG is rotationally driven by electric power stored in the battery 44, and outputs power for traveling of the vehicles 10. In this specification, the torque, the driving force, the power, and the force (power) are synonymous with each other unless otherwise specified. In addition, the electric motor MG generates electric power by driving power input from the engine 12 via the clutch K0, or converts the driven power input from the pair of drive wheels 14 into electric power by regeneration and generates electric power. The generated electric power is charged to the battery 44 via the inverter 42.

The power transmission device 16 includes, in order from the engine 12 side, an engine connection shaft 28, a clutch K0, an electric motor coupling shaft 30, a torque converter 20, an input shaft 32 which is an input rotation member of the automatic transmission 22, an automatic transmission 22, and the like in the case 18 which is a non-rotation member attached to the vehicle body, and these are well-known configurations. Further, the power transmission device 16 includes an output shaft 34, a propeller shaft 36, a differential 24, a pair of axles 38, and the like, which are output rotation members of the automatic transmission 22, and these are well-known configurations. The clutch K0 is an engagement device capable of connecting and disconnecting power transmission between the engine 12 and the electric motor MG, and is, for example, a wet-type multi-plate type hydraulic frictional engagement device.

The torque converter 20 is a known torque converter. The torque converter 20 includes a pump impeller 20a coupled to the electric motor coupling shaft 30, a turbine impeller 20b coupled to the input shaft 32, and a lockup clutch LU that directly couples the pump impeller 20a and the turbine impeller 20b. The torque converter 20 is a fluid transmission device capable of transmitting power input from a driving power source (the engine 12, the electric motor MG) to the input shaft 32 via a fluid. Vehicle 10 comprises a mechanical oil pump 26, for example, connected to a pump impeller 20a. The oil pump 26 is rotationally driven by a driving power source (engine 12, electric motor MG) to discharge hydraulic oil.

The starter motor 46 is a motor for starting the engine 12, and is, for example, a well-known motor capable of cranking the engine 12 by meshing with a ring gear cut in an outer peripheral portion of the flywheel.

The hydraulic control circuit 40 supplies required hydraulic oil to the respective parts in the case 18 using the hydraulic pressure of the hydraulic oil discharged from the mechanical oil pump 26 connected to the pump impeller 20a, for example, as the 20 original pressure.

In the vehicle 10, a traveling mode of either BEV traveling mode or the engine-traveling mode can be selected. BEV traveling mode is a traveling mode in which the engine 12 is stopped and traveling is performed in a Battery Electric Vehicle (BEV where only the electric motor MG is used as a power source for traveling. The engine traveling mode is a traveling mode in which at least the engine 12 is used as a power source for traveling. In BEV running, the clutch K0 is in the released state, and in the engine running, the clutch K0 is in the engaged state.

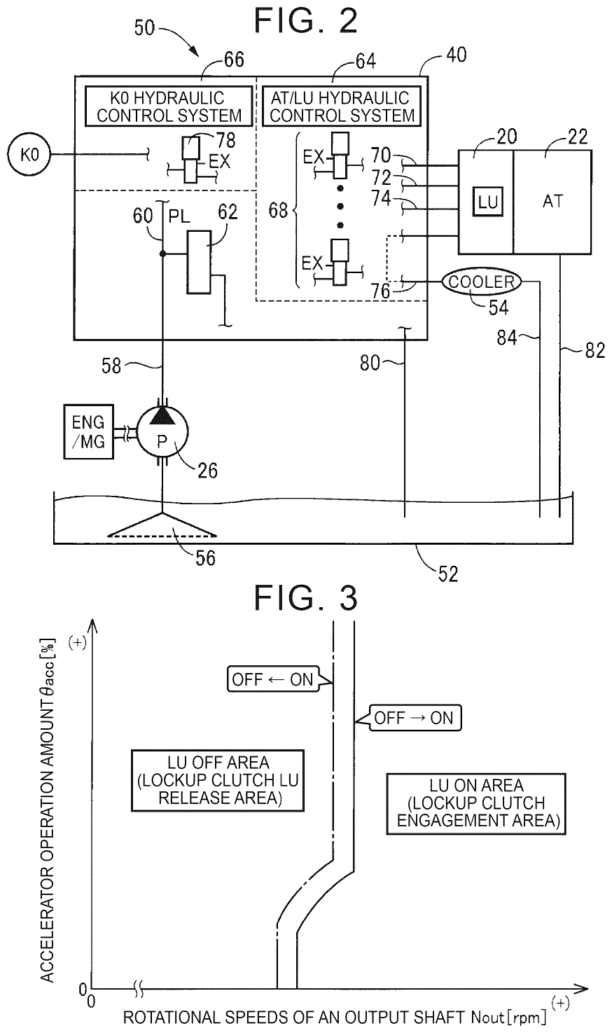

FIG. 2 is a schematic configuration diagram of the hydraulic system 50 for controlling the operation of the clutch K0, the torque converter 20, and the automatic transmission 22 shown in FIG. 1.

The hydraulic system 50 includes, in addition to the oil pump 26 and the hydraulic control circuit 40, an oil pan 52 provided in a lower portion of the case 18, and an oil cooler 54 that warms the hydraulic oil at a low temperature and cools the hydraulic oil after the completion of warm-up. The oil pump 26 is rotationally driven by the engine 12 and/or the electric motor MG to generate the original pressure of the hydraulic oil supplied to the hydraulic control circuit 40. The oil pump 26 sucks the hydraulic oil recirculated to the oil pan 52 from the suction port 56 and discharges the hydraulic oil to the discharge oil passage 58. The discharge oil passage 58 is connected to an oil passage (for example, a line pressure oil passage 60 through which the line pressure PL[Pa] flows) in the hydraulic control circuit 40.

The hydraulic control circuit 40 includes a primary regulator valve 62 that regulates the line pressure PL using the hydraulic pressure outputted (generated) from the oil pump 26 as an original pressure, a K0 hydraulic pressure control system 66 that controls the transmission operation of the automatic transmission 22 and the engagement and disengagement state (=connected state and disconnected state) of the clutch K0 using the line pressure PL as an original pressure, and a AT/LU hydraulic pressure control system 64 that controls the engagement and disengagement state of the clutch K0 using the line pressure PL as an original pressure.

AT/LU hydraulic control system 64 includes a plurality of solenoid valves 68 for regulating the hydraulic oil to be supplied to the hydraulic actuator in the automatic transmission 22, controlling the hydraulic oil to be supplied to the lockup clutch LU, switching the oil passage through which the hydraulic oil flows, releasing the oil passage, and shutting off the oil passage. The oil passage is, for example, an oil passage 70 connected to a hydraulic actuator in the automatic transmission 22, an oil passage 72 connected to the lockup clutch LU, a lubricating oil passage 74 connected to each portion of the power transmission path PT including the automatic transmission 22, a cooler oil passage 76 connected to the oil cooler 54, and the like. AT/LU hydraulic control system 64 configured as described above controls the supply and discharge of the hydraulic fluid for the operation of the automatic transmission 22 and the torque converter 20 with the lockup clutch LU via the solenoid valve 68. Operations related to the torque converter 20 with the automatic transmission 22 and the lockup clutch LU are, for example, maintenance of the gear ratio γat of the automatic transmission 22, transmission operation of the automatic transmission 22, lubrication of each part by the hydraulic oil via the lubricating oil passage 74, warm-up and cooling of the hydraulic oil via the oil cooler 54, and connection and disconnection control of the lockup clutch LU.

K0 hydraulic control system 66 includes a solenoid valve 78 that regulates the hydraulic OIL supplied to the clutch K0. K0 hydraulic control system 66 controls the operation related to the clutch K0 by controlling the supplying and discharging of the hydraulic fluid for the operation related to the clutch K0 via the solenoid valve 78. The operation related to the clutch K0 is, for example, the connection/disconnection control of the clutch K0. The hydraulic oil discharged in accordance with the operation of the solenoid valves 68 and 78, the hydraulic oil supplied to the respective portions of the power transmission path PT including the automatic transmission 22 via the lubricating oil passage 74, the hydraulic oil discharged from the oil cooler 54, and the like are recirculated to the oil pan 52 via the respective drain oil passages 80, 82, and 84.

Return to FIG. 1. The vehicle 10 can switch between the manual driving mode and the automatic driving mode as the driving mode, that is, can alternatively select the driving mode. The manual driving mode is a traveling method based on a manual operation by a driver, and the automatic driving mode is a traveling method that is not based on a manual operation by a driver. The autonomous driving mode is a driving mode in which the vehicle 10 is controlled to travel toward the target position on the basis of a predetermined target position (=target position information), a current position (=current position information), and the like without depending on an operation by the driver. Note that “automatic driving” in the present disclosure is one in which at least acceleration/deceleration is controlled without depending on manual operation by a driver.

During the manual driving mode, that is, during the manual driving mode, for example, the accelerator operation amount θacc [%] operated by the driver and the actual vehicle speed V [km/h] are applied to the driving request amount map, so that the required driving amount requested by the driver to the vehicle 10 is calculated. The drive request amount map is, for example, a map in which the relationship between the accelerator operation amount θacc and the vehicle speed V and the drive request amount is experimentally or by design predetermined and stored. The drive demand amount is a load on the power source (for example, a required drive torque Trdem [Nm] which is a demand amount of the drive torque Tr [Nm] in the pair of drive wheels 14), and corresponds to a “power load” in the present disclosure. In order to realize the required driving torque Trdem, the engine torque Te [Nm] which is the output torque of the engine 12, MG torque Tmg [Nm] which is the output torque of the electric motor MG, the gear ratio γat of the automatic transmission 22, and the like are controlled. For example, when the vehicle is traveling in BEV mode and during the manual driving mode, MG torque Tmg is controlled so as to realize the required driving torque Trdem based on the manual operation of the driver. At this time, when it is determined that the required driving torque Trdem cannot be realized only by MG torque Tmg, the engine 12 is started and the engine is switched from BEV running to the engine running. Thus, in order to realize the required drive torque Trdem, the required drive torque Trdem is realized since the engine torque Te can be used in addition to the MG torque Tmg. Since the request for switching from BEV running to the engine running during the manual driving is due to the increased required driving torque Trdem based on the manual operation of the driver, the engine starting needs to be performed with good responsiveness. If the engine is started with good responsiveness, Tr of driving torque transmitted from the power transmission path PT to the pair of drive wheels 14 may be increased in a short period of time, which may cause a shock. In order to suppress the occurrence of this shock, the lockup clutch LU needs to be released so that the power transmission in the torque converter 20 is made fluid-borne.

During the autonomous driving mode, that is, during the autonomous driving mode, the travel plan of the vehicle 10 along the target route set by the driver is created, that is, the route of the vehicle 10 is determined, on the basis of, for example, map data stored in advance in the navigation system, the current position of the vehicle 10, peripheral information of the vehicle 10 (such as the position and the traveling direction of the other vehicle), the vehicle speed V and the acceleration Acc [m/sec²] of the vehicle 10, and the like.

Based on the route of the vehicle 10 and the map data described above, the inclination angle of the road on which the vehicle 10 is going to travel is acquired, and the required driving torque Trdem in the future is predicted according to the present vehicle speed V, the inclination angle of the road on which the vehicle 10 is going to travel, and the like. In this way, during autonomous driving, the required driving torque Trdem in the future is predicted from the traveling plan, and the engine 12 and the electric motor MG are automatically controlled so that the actual driving torque Tr becomes as predicted with respect to the predicted required driving torque Trdem.

For example, when the vehicle is traveling in BEV mode and during the automated driving mode, MG torque Tmg is controlled so as to realize the predicted required driving torque Trdem. When it is predicted that the required driving torque Trdem in the future is larger than the predetermined torque determination value Trdem_jdg, the engine 12 is started in advance and the vehicle is switched from BEV running to the engine running. The predetermined torque determination value Trdem_jdg is a predetermined determination value determined experimentally or designed in advance in order to determine that the required driving torque Trdem in the future cannot be realized only by MG torque Tmg. The predetermined torque determination value Trdem_jdg corresponds to the “predetermined load determination amount” in the present disclosure. As described above, the switching from BEV running to the engine running during the automated driving is performed, for example, on the basis of predicting that the required driving torque Trdem during the automated driving is larger than the predetermined torque determination value Trdem_jdg.

For example, when the vehicle is traveling in BEV mode and during autonomous driving, the engine 12 is started in advance and the vehicle is switched from BEV driving to the engine driving in a case where it is predicted that the future state-of-charge SOC [%] is less than the predetermined engine start-threshold SOC_jdg. The state-of-charge SOC is the actual amount of charge stored relative to the full charge capacity of the predetermined battery 44. The predetermined engine start threshold value SOC_jdg is a predetermined threshold value for determining that the engine 12 is the state-of-charge SOC that needs to be automatically started to charge the battery 44.

Since the request for switching from BEV running to the engine running during the automated driving is known in advance based on the travel plan of the vehicle 10, the period required for starting the engine is set longer than the period required for switching from BEV running to the engine running during the manual driving. In switching from BEV running to engine running during autonomous driving, the engine 12 may be started for such a long time, and thus engine starting does not need to be performed with good responsiveness. Therefore, the switching from BEV running to the engine running during the autonomous driving is performed in such a manner that a shock generated in the power transmission path PT is suppressed as compared with the switching from BEV running to the engine running during the manual driving.

The electronic control unit 100 is configured to include a so-called microcomputer that is equipped with, for example, a CPU, a RAM, a ROM, an input/output interface and the like. The CPU performs various kinds of control of the vehicle 10 by performing signal processing in accordance with a program stored in advance in the ROM, while utilizing a temporary storage function of the RAM. Note that the electronic control unit 100 corresponds to a “control device” in the present disclosure.

The electronic control unit 100 receives inputs of various signals (for example, an engine rotational speed sensor 90, an input shaft rotational speed sensor 92, an output shaft rotational speed sensor 94, an MG rotational speed sensor 96, an accelerator operation amount sensor 98, a battery sensor 88, and the like) based on detected values of various sensors (for example, an engine rotational speed Ne [rpm], an input shaft rotational speed Nin [rpm] that is the same value as the turbine rotational speed Nt, an output shaft rotational speed Nout that corresponds to the vehicle speed V, a MG rotational speed Nmg [rpm] that is the same value as the pump rotational speed Np), an accelerator operation amount θacc that is an accelerator operation amount of a driver that represents a magnitude of an acceleration operation of the driver, and the state-of-charge SOC of the battery 44. The engine rotational speed Ne is the rotational speed of the engine 12, and the turbine rotational speed Nt is the rotational speed of the turbine blade impeller 20b. The input shaft rotational speed Nin is a rotational speed of the input shaft 32. The pump rotational speed Np is the rotational speed of the pump impeller 20a, and MG rotational speed Nmg is the rotational speed of the electric motor MG.

From the electronic control unit 100, various command signals (for example, an engine control signal Se for controlling the engine 12, a K0 control signal Sk0 for controlling the engagement and disengagement of LU control signal Slu, clutch K0 for controlling the engagement and disengagement of the shift control signal Sat, lockup clutch LU for controlling the shift of the automatic transmission 22, a MG control signal Smg for controlling the rotation of the electric motor MG via the inverter 42, a starter motor control signal Ss for controlling the rotation of the starter motor 46, and the like) are respectively outputted to the respective devices (for example, the engine 12, the hydraulic control circuit 40, the inverter 42, the starter motor 46, and the like) provided in the vehicle 10.

The electronic control unit 100 functionally includes a BEV travel determination unit 102, a driving mode determination unit 104, and a lockup clutch control unit 106.

BEV travel determination unit 102 determines whether or not the vehicles 10 are traveling in a BEV mode.

The driving mode determination unit 104 determines whether or not the vehicle 10 is in autonomous driving.

When BEV travel determination unit 102 determines that the vehicle is in BEV travel and the driving mode determination unit 104 determines that the vehicle is in autonomous driving, the lockup clutch control unit 106 controls the lockup clutch LU to be engaged.

When either BEV travel determination unit 102 determines that the vehicle is not in BEV travel or the driving mode determination unit 104 determines that the vehicle is in manual drive, the lockup clutch control unit 106 controls the connection/disconnection state of the lockup clutch LU in accordance with a predetermined connection/disconnection condition determined in advance. The predetermined connection/disconnection condition is, for example, a predetermined lock-up switching map.

FIG. 3 is an exemplary lock-up switching map that is determined in advance as the connection/disconnection condition of the lockup clutch LU. In FIG. 3, the connection/disconnection state of the lockup clutch LU is set based on the vehicle state of the vehicle 10 represented on the two-dimensional coordinates of the output-shaft rotational speed Nout and the accelerator operation amount θacc. In the lock-up switching map, the vehicle speed V or the like may be used instead of the output-shaft rotational speed Nout, or the throttle valve opening θth, the required driving torque Trdem, or the like may be used instead of the accelerator operation amount θacc.

In the lock-up switching map, an on→off switching line for switching the lockup clutch LU from the engaged state (=ON state) to the released state (=OFF state), and an off→on switching line for switching the lockup clutch LU from the released state (=OFF state) to the engaged state (=ON state) are determined in advance. For example, in FIG. 3, when the point represented by the actual output-shaft rotational speed Nout and the accelerator operation amount θacc, which are variables, crosses the on→off switching line or the off→on switching line, the release control or the engagement control of the lockup clutch LU is determined to be started.

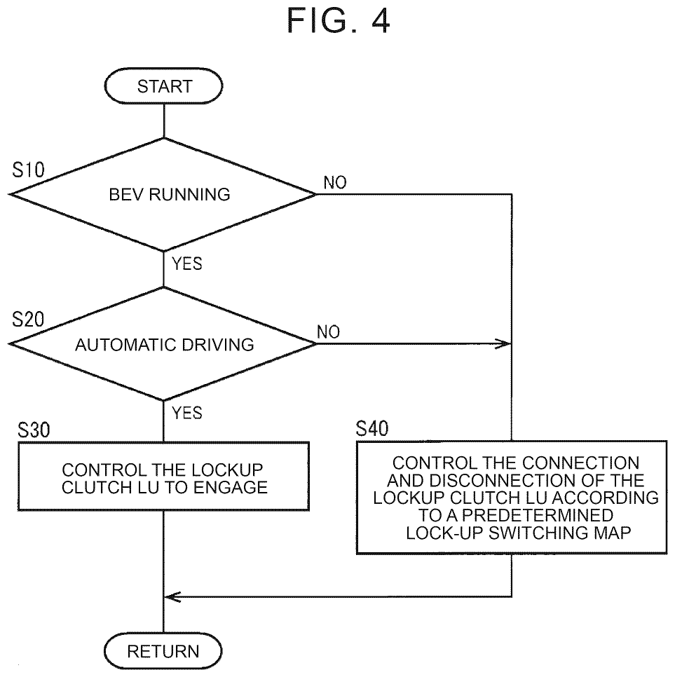

FIG. 4 is an example of a flowchart for explaining a control operation of the electronic control unit 100 illustrated in FIG. 1. The flowchart of FIG. 4 is repeatedly executed while the vehicle is running.

First, it is determined whether or not the vehicles 10 are traveling in a BEV mode in a step (hereinafter, step is omitted) S10 corresponding to the function of BEV traveling determination unit 102. When the determination of S10 is YES, it is determined whether or not the vehicle 10 is traveling autonomously in S20 corresponding to the function of the driving mode determination unit 104. When the determination of S20 is YES, the lockup clutch LU is controlled to be engaged in S30 corresponding to the function of the lockup clutch control unit 106. When the determination of S10 is NO and the determination of S20 is NO, the engagement and disengagement of the lockup clutch LU is controlled in accordance with the lock-up switching map in S40 corresponding to the function of the lockup clutch control unit 106. After S30 is executed and after S40 is executed, both returns are returned.

According to the present embodiment, (a) the automatic driving and the manual driving are switchable, (b) the lockup clutch LU is controlled in accordance with the lock-up switching map during BEV driving and the manual driving, and (c) the lockup clutch LU is engaged during BEV driving and the automatic driving. This makes it possible to accurately control the driving torque Tr and the rotational speed of the pair of drive wheels 14 during the autonomous driving.

According to the present embodiment, the switching from BEV running to the engine running during the automated driving is performed based on the estimation that the required driving torque Trdem during the automated driving is larger than the predetermined torque determination value Trdem_jdg. Since the switching from BEV running to the engine running during the automated driving is performed in advance based on the predicted required driving torque Trdem, the responsiveness of the engine start is not required as much as during the manual driving. Therefore, even if the lockup clutch LU is engaged during the autonomous driving and BEV driving, the switching from BEV driving to the engine driving is suppressed.

According to the present embodiment, the switching from BEV running to the engine running during the autonomous running is performed on the basis of the estimation that the state-of-charge SOC of the battery 44 that transmits and receives electric power to and from the electric motor MG is less than the engine start threshold SOC_jdg. Since the switching from BEV running to engine running during autonomous driving is performed in advance based on the estimation of the state-of-charge SOC, the responsiveness of the engine start is not required as much as during manual driving. Therefore, even if the lockup clutch LU is engaged during the autonomous driving and BEV driving, the switching from BEV driving to the engine driving is suppressed.

According to the present embodiment, the lockup clutch LU is controlled to be connected and disconnected in accordance with a predetermined lock-up switching map both during manual driving and during engine-running. As a result, the engine start is performed with good responsiveness while the occurrence of the shock is suppressed, and the fuel efficiency of the engine 12 during the engine running is easily improved.

It should be noted that the above-described embodiments of the present disclosure are examples of the present disclosure, and the present disclosure can be implemented in various modifications and improvements based on the knowledge of a person skilled in the art without departing from the gist thereof.

What is claimed is:

1. A hybrid electric vehicle control device comprising: an engine and an electric motor as power sources for travel; and a torque converter with a lockup clutch provided in a power transfer path between the electric motor and a pair of drive wheels, wherein:
the hybrid electric vehicle control device is able to switch between autonomous travel and manual travel;
engagement-disengagement control of the lockup clutch is performed according to a predetermined engagement-disengagement condition during battery electric vehicle travel in which only the electric motor is used as the power source and during the manual travel; and
the lockup clutch is engaged during the battery electric vehicle travel and during the autonomous travel.

2. The hybrid electric vehicle control device according to claim 1, wherein switching from the battery electric vehicle travel to engine travel in which the power source includes at least the engine during the autonomous travel is made based on a prediction that a power load during the autonomous travel will become greater than a predetermined load determination amount.

3. The hybrid electric vehicle control device according to claim 1, wherein switching from the battery electric vehicle travel to engine travel in which the power source includes at least the engine during the autonomous travel is made based on a prediction that a state-of-charge value of a battery that transmits and receives electric power to and from the electric motor will become less than an engine start threshold.

4. The hybrid electric vehicle control device according to claim 1, wherein the engagement-disengagement control of the lockup clutch is performed according to the predetermined engagement-disengagement condition during engine travel in which the power source includes at least the engine.
